(19) United States
(12) Patent Application Publication
(10) Pub. No.: US 2009/0141738 A1
(43) Pub. Date: Jun. 4, 2009

(54) Reservation-Based Distributed Collision Avoidance Channel Access For Wireless Local Area Networks

(76) Inventor: Qing Li, San Jose, CA (US)

Correspondence Address: MATTINGLY & MALUR, P.C., 1800 DIAGONAL ROAD, SUITE 370, ALEXANDRIA, VA, 22314, US

(21) Appl. No.: 11/949,595

(22) Filed: Dec. 3, 2007

(51) Int. Cl. H04L 12/413

(52) U.S. Cl. 370/448

(57) ABSTRACT

Each station on a wireless network comprises memory indicating whether it is in an IN or an OUT state; a reservation store storing reserved time slots of other stations on the network; a backoff counter (BC) value determination engine for selecting an unreserved time slot in the reservation store as the next time slot for a next transmission if in the IN state, and for determining the next time slot according to a predetermined algorithm if in the OUT state; and a medium access engine for initiating a current transmission during a previously reserved time slot and after a first idle interval if in the IN state, and for initiating the current transmission during a previously determined time slot and after a second idle interval shorter than the first idle interval if in the OUT state, the current transmission identifying the next time slot.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This invention relates generally to wireless networks, and more particularly provides reservation-based distributed collision avoidance channel access for wireless local area networks.

### BACKGROUND

As users experience the convenience of wireless connectivity, they are demanding increasing support. Typical applications over wireless networks include video streaming, video conferencing, and distance learning. Because wireless bandwidth availability is restricted, quality of service (QoS) management is increasingly important in 802.11 wireless local area networks (WLANs).

The original 802.11 media access control (MAC) protocol was designed with two modes of communication for wireless stations (STAs). The first mode, Distributed Coordination Function (DCF), is based on Carrier Sense Multiple Access with Collision Avoidance (CSMA/CA), sometimes referred to as “listen before talk.” A wireless station (STA) waits for a quiet period on the network and then begins to transmit data and detect collisions. The second mode, Point Coordination Function (PCF), supports time-sensitive traffic flows. Using PCF, wireless access points (APs) periodically send beacon frames to communicate network identification and management parameters specific to the WLAN. Between beacon frames, PCF splits time into a contention period (CP) where the STAs implement a DCF protocol, and a contention-free period (CFP) where an AP coordinates access by the various STAs based on QoS requirements.

In DCF, traffic contention for the STAs use the medium access parameters—the DCF interframe space (DIFS) interval and contention window (CW, CWmin and CWmax). Generally, DIFS defines the time interval that a STA (or AP) must sense the wireless medium to be idle before invoking a transmission or backoff mechanism. The contention window (CW, CWmin and CWmax) indicates the number of backoff time slots until the STA attempts a transmission. The contention window is selected as a random backoff number of time slots between 0 and CW. CW starts at CWmin. CW is essentially doubled every time a collision occurs until CW reaches its maximum value CWmax. Then, CW maintains the maximum value CWmax until the number of retransmissions exceeds a retry limit. Upon gaining access to the wireless channel, the STA continues to send fragments until either all fragments of a single MAC Service Data Unit (MSDU) or MAC Management Protocol Data Unit (MMPDU) have been sent, an ACK is not received, or the STA is restricted from sending any additional fragments due to a dwell time boundary. Each fragment and corresponding ACK is separated by a short interframe space (SIFS) interval. The DIFS interval is defined as the SIFS interval plus two time slots. Accordingly, since a STA must wait for the channel to be idle for at least a DIFS interval, no STA awaiting use of the channel will initiate a transmission until an active STA has completed its current transmission.

FIG. 1 is a diagram illustrating the DCF access mechanism, as well as the SIFS interval and the DIFS interval. Generally, the DIFS interval is defined as the SIFS interval plus two time slots. The PCF Interframe Space (PIFS) interval is defined as the SIFS interval plus one time slot.

With these medium access parameters, DCF generally works in the following manner:

Before a transmitting STA awaiting to transmit can initiate any transmission, the STA must first sense the channel idle for a DIFS interval. If the channel is still idle after the initial DIFS interval, then the transmitting STA initiates its transmission. If a collision occurs, then the transmitting STA invokes a backoff procedure using a backoff counter to count down a random number of backoff time slots selected between 0 and CW (initially set to CWmin). The transmitting STA decrements the backoff counter by one for each time slot while the channel is sensed to be idle. If the transmitting STA senses the channel to be busy at any time during the backoff procedure, then the transmitting STA suspends the backoff countdown, freezing its backoff counter until the channel is sensed to be idle for a DIFS interval again. Then, if the channel is still idle, the transmitting STA resumes decrementing its backoff counter.

When the backoff counter reaches zero, the transmitting STA initiates its transmission. If a collision occurs, then the transmitting STA invokes another backoff procedure, possibly increasing the size of CW. That is, as stated above, after each unsuccessful transmission, CW is essentially doubled until it reaches CWmax. After a successful transmission, CW returns to its default value of CWmin.

Because DCF is based on a distributed contention mechanism, simultaneous transmissions from different STAs causes collisions and results in packet losses and retransmissions. Further, each STA has to wait for a certain amount of backoff time to avoid collisions before each retransmission, thus leading to additional bandwidth waste.

Example prior art references include the following:
[1] “Wireless LAN Media Access Control (MAC) and Physical Layer (PHY) Specification;” IEEE Standard 802.11, 1999.
[2] Rusty O. Baldwin, Nathaniel J. Davis IV, Scott F. Midkiff, “A real-time Medium Access Control Protocol for Ad hoc Wireless Focal Area Networks”, Mobile Computing and Communications Review, 3(2): 20-27, April 1999, Blacksburg, Va.
[3] U.S. Pat. No. 5,231,634.
[4] U.S. Pat. No. 5,570,355.
[5] U.S. Pat. No. 6,331,973.
[6] U.S. Pat. No. 7,206,319.
[7] U.S. Pat. No. 7,245,604.

### SUMMARY

Embodiments of the invention perform reservation-based distributed collision avoidance channel access in wireless local area networks (WLANs). By advertising future channel access parameters in advance, embodiments reduce the number of idle time slots and avoid collisions. Consequently, embodiments may be suitable for traffic with delay requirements, e.g., multimedia delivery.

In one embodiment, each STA advertises its next backoff counter (BC) value during its current packet transmission. All other STAs store the advertised BC value in a reservation table as a reserved time slot. If another STA receives a BC value from a current transmission that is the same as its scheduled BC value, the other STA noting the match effectively reschedules its next transmission.

In one embodiment, each STA manages its state as one of IDLE, IN or OUT. IDLE defines the state of a STA when the STA does not have any packets to send. IN defines the state of a STA when its next BC value has been successfully advertised to other STAs. A STA presumes a successful advertisement when no collision occurred during the transmission of its data frame containing the BC value and when the STA receives a success indication, e.g., that the packet has a correct cyclic redundancy check (CRC), e.g., an ACK. OUT defines the state of a STA when the BC value of the STA is unknown to other STAs, and includes the circumstances when a STA has just joined the network, when a STA has just experienced a transmission failure (e.g., because a collision occurred and/or because of failure to receive a success indication), and when a STA has just received an advertised BC value that matches its scheduled BC value.

In one embodiment, each station in the IN state transmits alter a DIFS interval alter its backoff timer reaches zero. The STA selects and advertises its next BC value as the smallest available value in the reservation table. If the transmission of a STA in the IN stale fails, e.g., due to a collision or due to a failed success indication, the STA selects a BC value from the uniform distribution between 0 and CW and switches to the OUT state (since the failure suggests that the other STAs are not aware of its BC value). Also, if a STA receives an advertised BC value that matches its next value, the STA switches to the OUT state (since the selection by another suggests that the other STAs are not aware of its BC value), continuing with its previously advertised BC value.

In one embodiment, each STA in the OUT state gains channel access after the channel is idle for a SIFS interval plus 1 timeslot (equal to a PIFS interval) after the backoff timer reaches zero. Since a STA in the OUT state gains access after a PIFS interval and a STA in the IN state gains access after a DIFS interval, a STA in the OUT state has higher channel access priority than the STA in the IN state. When a STA is transmitting on the RDCA network 200 for the first time, the STA generates and advertises its next BC value as a random value from a uniform distribution between 0 and CW. Otherwise, when a STA is not transmitting in the RDCA network 200 for the first time, the STA selects and advertises the smallest available BC value in the reservation table as its next BC value. After a successful transmission from the OUT state, the STA switches to the IN stale. When a STA in the OUT state has a transmission failure, then the STA determines CW per conventional DCF procedures, selects a new BC value from the uniform distribution between 0 and CW, and remains in the OUT state.

In one embodiment, the present invention provides a first station for communicating on a wireless network, the station comprising memory for indicating whether the first station is in an IN state or an OUT state; a reservation store for storing reserved time slots of other stations communicating on the wireless network; a backoff counter (BC) value determination engine for selecting one of the unreserved time slots in the reservation store as the next time slot for a next transmission if the first station is in the IN state, the BC value determination engine for determining the next time slot according to a predetermined algorithm if the first station is in the OUT state; and a medium access engine for initiating a current transmission during a previously reserved time slot and after a first idle interval if the first station is in the IN state, and for initiating the current transmission during a previously determined time slot and after a second idle interval if the first station is in the OUT state, the second idle interval being shorter than the first idle interval, the current transmission identifying the next time slot.

The first station may include a mobile device or an access point. The BC value determination engine may select the lowest available time slot as the next time slot if the first station is in the IN state. The BC value determination engine may select the next time slot using a uniform distribution between 0 and a contention window (CW) value if the first station is in the OUT state and it's the first transmission of the station. The first idle interval may include a DIFS interval and the second idle interval may include a PIFS interval. The first station may further comprise a backoff counter for counting the time slots until the next time slot. The first station may further comprise a state engine for controlling the state of the first station, the state engine for placing the first station in the IN state after a successful transmission and for placing the first station in the OUT state after an unsuccessful transmission. The state engine may control the state of the first station to switch from the IN state to the OUT state when another time slot is advertised that matches the next time slot of the first station. The state engine may control the state of the first station to switch from the IN state to the OUT state upon a collision. The state engine may control the state of the first station to switch from the IN state to the OUT state upon failure of a success indication. The state engine may control the state of the first station to initiate in the OUT state upon joining the wireless network.

Per one embodiment, the present invention provides a method of communicating on a wireless network by a first station, the method comprising storing an indication whether the first station is in an IN state or an OUT state; storing reserved time slots of other stations communicating on the wireless network in a reservation store; storing a previously determined time slot of the first station; selecting one of the unreserved time slots in the reservation store as the next time slot if the first station is in the IN state; generating the next time slot according to a predetermined algorithm if the first station is in the OUT state; initialing a current transmission daring the previously determined time slot and after a first idle interval if the first station is in the IN state; and initiating the current transmission during the previously determined time slot and after a second idle interval if the first station is in the OUT state, the second idle interval being shorter than the first idle interval, the current transmission identifying the next time slot.

The computing may include selecting the lowest available time slot as the next time slot if the station is in the IN state. The computing may include selecting the next time slot using a uniform distribution between 0 and a contention window (CW) value and it's the first transmission of the first station. The first idle interval may include a DIFS interval and the second idle interval may include a PIFS interval. The method may further comprise placing the first station in the IN state after a successful transmission, and placing the first station in the OUT state after an unsuccessful transmission. The method may further comprise switching the state of the first station from the IN state to the OUT state when another time slot is advertised that matches the next time slot of the first station. The method may further comprise switching the state of the first station from the IN state to the OUT state upon a collision. The method may further comprise switching the state of the first station from the IN state to the OUT state upon failure of a success indication. The method may further comprise causing the state of the first station to initiate in the OUT state upon joining the wireless network.

### BRIEF DESCRIPTION OF THE DRAWINGS

FIG. 1 is a timing diagram illustrating the prior art DCF mechanism according to the prior art.

FIG. 2A is a block diagram illustrating an RDCA network, in accordance with an embodiment of the present invention.

FIG. 2B is a block diagram illustrating details of an AP or STA of FIG. 2A, in accordance with an embodiment of the present invention.

FIG. 3 is a block diagram illustrating details of the RDCA controller, in accordance with an embodiment of the present invention.

FIG. 4 is a timing diagram illustrating reservation table management for two STAs, in accordance with an embodiment of the present invention.

FIG. 5(a) is a timing diagram illustrating reservation table management for a first STA that is joining an RDCA network 200, in accordance with an embodiment of the present invention.

FIG. 5(b) is a timing diagram illustrating reservation table management for the first STA of FIG. 5(a) after it reaches steady-state in the RDCA network 200, in accordance with an embodiment of the present invention.

FIG. 6(a) is a timing diagram illustrating a second STA that is joining the RDCA network 200 of FIG. 5(b) with the first STA in steady-state, in accordance with an embodiment of the present invention.

FIG. 6(b) is a timing diagram illustrating reservation table management of the first and second STAs FIG. 6(a) as they achieve steady-state, in accordance with an embodiment of the present invention.

FIG. 6(c) is a timing diagram illustrating the first and second STAs of FIG. 6(b) after they reach steady-state, in accordance with an embodiment of the present invention.

FIG. 7(a) is a timing diagram illustrating a second STA and a third STA simultaneously joining the RDCA network 200 of FIG. 5(b), in accordance with an embodiment of the present invention.

FIG. 7(b) is a timing diagram illustrating the backoff timing mechanism handling the simultaneous joining of the second and third STAs of FIG. 7(a), in accordance with an embodiment of the present invention.

FIG. 8 is a timing diagram illustrating reservation table management when one of two STAs on the RDCA network 200 fails to transmit in its reserved time slot, in accordance with an embodiment of the present invention.

FIG. 9 is a state transition diagram, in accordance with an embodiment of the present invention.

FIG. 10 is a flowchart illustrating a method of performing reservation-based distributed collision avoidance, in accordance with an embodiment of the present invention.

FIG. 11 is a flowchart illustrating a method of handling received backoff counter values, in accordance with an embodiment of the present invention.

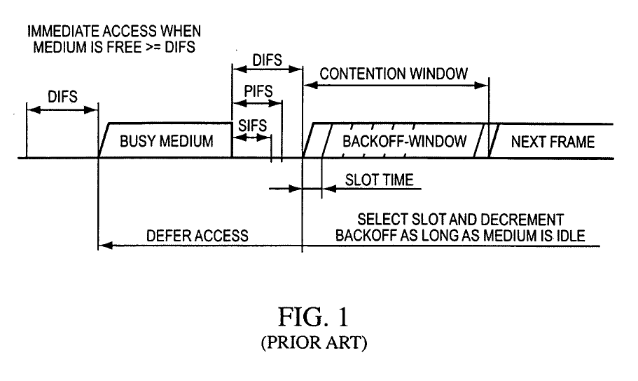

### DETAILED DESCRIPTION

The following description is provided to enable any person skilled in the art to make and use the invention. Various modifications to the embodiments are possible, and the generic principles defined herein may be applied to these and other embodiments and applications without departing from the spirit and scope of the invention. Thus, the invention is not intended to be limited to the embodiments and applications shown, but is to be accorded the widest scope consistent with the principles, features and teachings disclosed herein.

Embodiments of the invention perform reservation-based distributed collision avoidance channel access in wireless local area networks (WLANs). By advertising future channel access parameters in advance, embodiments reduce the number of idle time slots and avoid collisions. Consequently, embodiments maybe suitable for traffic with delay requirements, e.g., multimedia delivery.

Generally, each STA advertises its next backoff counter (BC) value during its current packet transmission. All other STAs store the advertised BC value in a reservation table as a reserved time slot. If another STA receives a BC value from a current transmission that is the same as its scheduled BC value, the other STA noting the match effectively reschedules its next transmission.

In one embodiment, each STA manages its state as one of IDLE, IN or OUT. IDLE defines the state of a STA when the STA does not have any packets to send. IN defines the state of a STA when its next BC value has been successfully advertised to other STAs. A STA presumes a successful advertisement when no collision occurred during the transmission of its data frame containing the BC value and when the STA receives a success indication, e.g., that the packet has a correct cyclic redundancy check (CEO), e.g., an ACK. OUT defines the state of a STA when the BC value of the STA is unknown to other STAs, and includes the circumstances when a STA has just joined the network, when a STA has just experienced a transmission failure (e.g., because a collision occurred and/or because of failure to receive a success indication), and when a STA has just received an advertised BC value that matches its scheduled BC value.

Each station in the IN state transmits after a DIFS interval after its backoff timer reaches zero. The STA selects and advertises its next BC value as the smallest available value in the reservation fable. If the transmission of a STA in the IN state fails, e.g., due to a collision or due to a failed success indication, the STA selects a BC value from the uniform distribution between 0 and CW and switches to the OUT state (since the failure suggests that the other STAs are not aware of its BC value). Also, if a STA receives an advertised BC value that matches its next value, the STA selects a BC value from the uniform distribution between 0 and CW and switches to the OUT state (since the selection by another suggests that the other STAs are not aware of its BC value), continuing with its previously advertised BC value.

Each STA in the OUT state gains channel access after the channel is idle for a SIFS interval plus 1 timeslot (equal to a PIFS interval) after the backoff timer reaches zero. Since a STA in the OUT state gains access after a PIFS interval and a STA in the IN state gains access after a DIFS interval, a STA in the OUT state has higher channel access priority than the STA in the IN state. When a STA is transmitting on the RDCA network 200 for the first time, the STA generates and advertises its next BC value as a random value from a uniform distribution between 0 and CW. Otherwise, when a STA is not transmitting in the RDCA network 200 for the first time, the STA selects and advertises the smallest available BC value in the reservation table as its next BC value. After a successful transmission from the OUT state, the STA switches to the IN state. When a STA in the OUT state has a transmission failure, then the STA determines CW per conventional DCF procedures, selects a new BC value from the uniform distribution between 0 and CW, and remains in the OUT state.

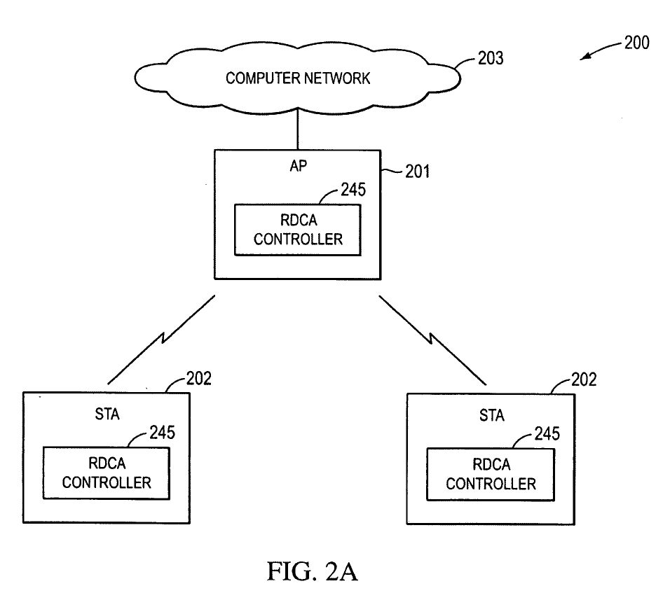

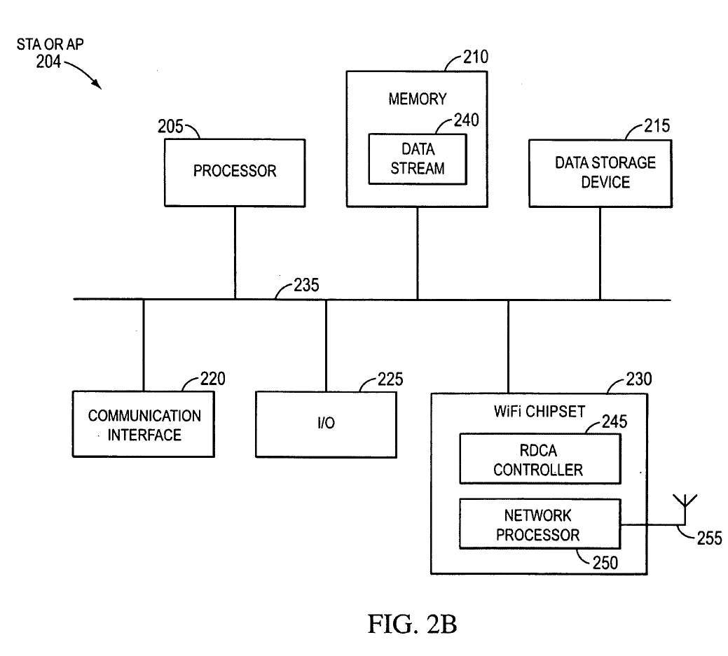

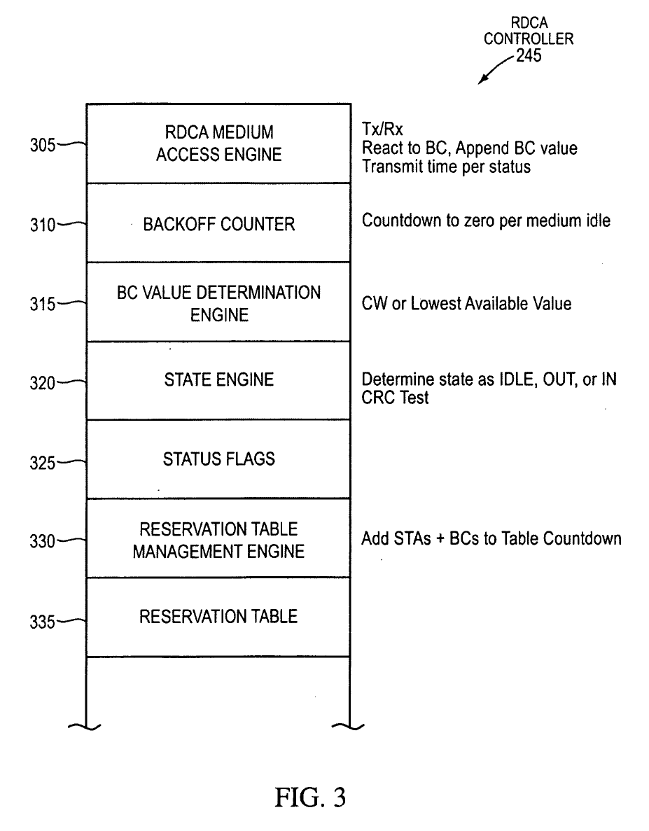

FIG. 2A is a block diagram illustrating an RDCA network 200, in accordance with an embodiment of the present invention. The RDCA network 200 includes an access point (AP) 201 coupled to a computer network 203 and in wireless communication with STAs 202. Each of the AP 201 and the STAs 202 includes an RDCA controller 245, which causes the AP 201 and STAs 202 to communicate using reservation-based distributed collision avoidance channel access. Details of the RDCA controller 245 are shown and described with reference to FIG. 2B and FIG. 3.

FIG. 2B is a block diagram illustrating details of an AP 201 and/or STA 202, in accordance with an embodiment of the present invention. Each of AP 201 and/or STA 202 is referred to genetically herein as STA 204. In one embodiment, each STA 204 includes a processor 205 (such as an Intel Pentium® microprocessor or a Motorola Power PC® microprocessor), memory 210 (such as random-access memory), a data storage device 215 (such as a magnetic disk), a communication interface 220 (such as a broadband modem that may be coupled to the Internet), input/output (I/O) 225 (such as a keyboard, mouse and LCD display), and a WiFi chipset 230, each coupled to the communication channel 235. One skilled in the art will recognize that, although the memory 210 and the data storage device 215 are illustrated as different units, the memory 210 and the data storage device 215 can be parts of the same unit, distributed units, virtual memory, etc. The term “memory” herein, is intended to cover all data storage media whether permanent or temporary.

The memory 210 stores a data stream 240 intended for transmission over a wireless medium. The WiFi chipset 230 includes an RDCA controller 245 and a network processor 250 coupled to a wireless antenna 255. Details of the RDCA controller 245 are shown and described with reference to FIG. 3.

FIG. 3 is a block diagram illustrating details of the RDCA controller 245, in accordance with an embodiment of the present invention. The RDCA controller 245 includes hardware, software and/or firmware capable of effecting reservation-based distributed collision avoidance mechanism. The RDCA controller 245 includes an RDCA medium access engine 305, a backoff counter 310, a BC value determination engine 315, a state engine 320, status flags 325, a reservation table management engine 330 and a reservation table 335.

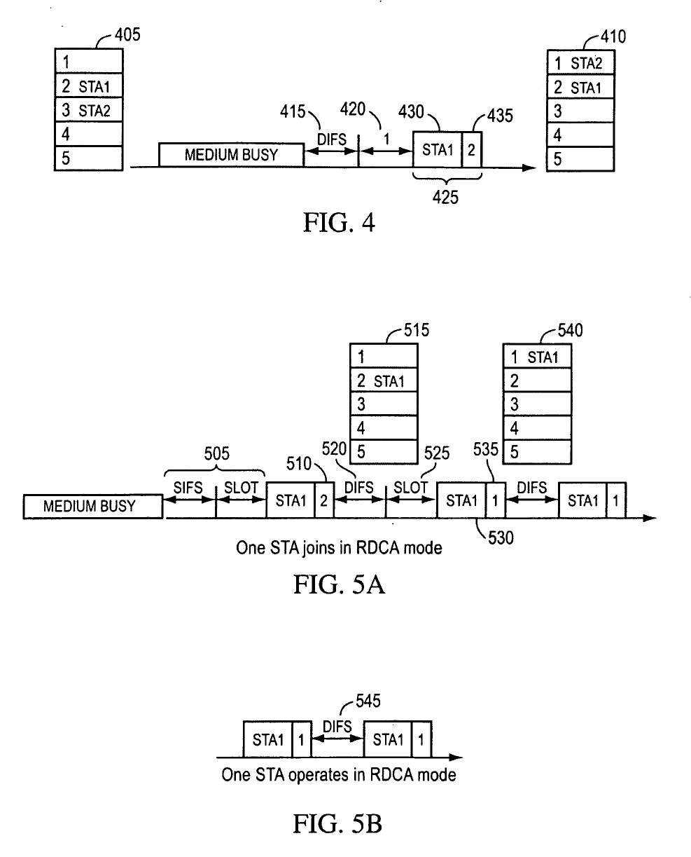

The RDCA medium access engine 305 packages data frames and controls transmission of the data frames to the wireless medium. In one embodiment, the RDCA medium access engine 305 appends the BC value to the payload. FIG. 4 illustrates an example data frame 425, which includes a payload 430 and a BC value 435. The RDCA medium access engine 305 initiates a transmission when the backoff counter is zero and after either a DIFS interval or a PIFS interval, depending on the state of the RDCA controller as being in the IN state or the OUT state. The RDCA medium access engine 305 also receives data frames from the wireless medium. When a STA no longer has any packets to send, the RDCA medium access engine 305 does not append a BC value in the packet to inform the other STAs that it is not reserving a time slot. Later, when the STA in IDLE has packets to send, the STA in IDLE follows the same procedure as newly joining STAs.

The backoff counter 310 counts down the number of idle time slots starting at the boundary of a DIFS interval until the current BC value reaches zero.

The BC value determination engine 315 determines the next BC value for advertisement and countdown. Upon joining the RDCA network 200, the BC value determination engine 315 generally follows conventional DCF protocol to select a BC value as a random value selected from a uniform distribution between 0 and CWmin. Then, upon a successful transmission, the STA shifts to the IN state. While in the IN state, the BC value determination engine 315 selects the lowest time slot available in the reservation table 335. Upon joining the RDCA network 200, the lowest available time slot in its reservation table 335 according to this STA may coincide with a time slot previously selected by another STA, since the joining STA has an incomplete reservation table 335 and thus is unaware of prior time slot reservations. For example, the STA 204 just joining the RDCA network 200 will likely choose slot 1 regardless. After a STA settles in the RDCA network 200, i.e., after the STA 204 has developed its reservation table 335, then the STA 204 will choose the lowest available time slot that has not been reserved by another STA 204. For example, if per the reservation table 335 two STAs in the IN state hold slots 1 and 2 and a third STA that just joined the RDCA network 200 holds slot 4, then the settled STA will select slot 3 (since it is the lowest available time slot). Further, if a STA is transitioning from the IN state to the OUT state because its previous transmission failed, then the BC value determination engine 315 selects a random value from a uniform distribution between 0 and CWmin as its next BC value. If a STA is transitioning from the IN state to the OUT state because another STA 204 has advertised a BC value mat matches its BC value, then in one embodiment the BC value determination engine 315 continues with the previously advertised BC value. If the STA is to remain in the OUT state, e.g., because it has experienced a successive failed transmission, then the BC value determination engine 315 modifies CW using conventional DCF procedures and selects a random value from a uniform distribution between 0 and CW as its next BC value. As stated above, for each successive failure, CW is essentially doubled until a maximum value CWmax and until a maximum number of successive attempts.

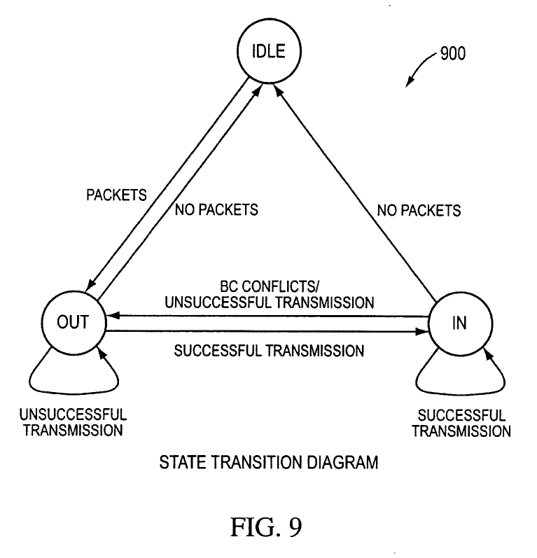

The state engine 320 includes hardware, software and/or firmware capable of determining the state of the STA as IDLE, IN or OUT and FIRST or NOT FIRST, and storing the states of the status flags 325. If the STA 200 has no data to transmit, the state engine 320 stores the state of the STA as IDLE. If the STA 200 has data to transmit and has successfully advertised its next BC value, then the state engine 320 stores the state as IN. If the STA has data to transmit for the first time in the. RDCA network 200, then the state engine 320 stores the states as OUT and FIRST. If the STA has data to transmit and its previous transmission failed (e.g., because of a collision or a failed ACK), then the state engine 320 stores the states as OUT and NOT FIRST. If a STA in the IN state receives an advertised BC value that is the same as its scheduled BC value, the STA switches the states to OUT and NOT FIRST. State switching is further described with reference to FIG. 9.

It will be appreciated that, if a STA broadcasts or multicasts packets, then there are no ACKs to differentiate whether the transmission is successful or not. Thus, in this scenario, a STA assumes that its broadcast/multicast transmissions are successful. The state engine 320 automatically switches to the IN state after the first transmission.

The reservation table management engine 330 includes hardware, software and/or firmware capable of managing the reservation table 335. The reservation table management engine 330 (possibly via the RDCA medium access engine 305) monitors the wireless medium for advertised BC values and STA IDs and stores them (including its own STA ID and BC value) in the reservation table 335. With the passing of each idle time slot beginning at the boundary of a DIFS interval, the reservation table management engine 330 reduces each of the reserved BC values by one. Further, to improve efficiency and reduce storage overhead, the reservation table management engine 330 may mark each time slot as a single bit. However, to simplify the description herein, each time slot in the reservation table 335 may be shown and described as a number. In one embodiment, since the reservation table management engine 330 maintains the BC values for all STAs, including for itself no separate backoff counter 310 is needed. In other words, the reservation table management engine 330 effectively includes a backoff counter 310. Since each STA 200 builds its reservation table 335 after joining the network 200, the reservation table 335 of each STA 200 may be different.

FIG. 4 is a timing diagram illustrating reservation table management for two STAs 204, in accordance with an embodiment of the present invention. The reservation table 405 illustrates the reservation table 335 stored by a first. STA (STA1) during the medium busy time. As shown, the reservation table 405 implies that STA1 reserves the second slot, while a second STA (STA2) reserves the third time slot. After a DIFS interval 415 after the medium becomes idle, STA1 decrements all values in the reservation table 405. After decrementing by 1, the BC value of STA1 is 1. Thus, STA1 must still wait an additional time slot 420 before initiating transmission of its data frame 425, which includes its payload 430 and next BC value 435. As shown, STA1 selects the lowest available time slot of 2, since STA2 currently reserves time slot 1. The reservation table 410 illustrates the reservation table 335 after STA1 advertises its new BC value.

FIG. 5(a) is a timing diagram illustrating reservation table management for a STA1 that is joining the RDCA network 200, in accordance with an embodiment of the present invention. When STA1 joins the RDCA network 200, STA1 sets its initial state as IDLE. If STA1 has any packets to send, STA1 sets its BC value to zero and state to OUT. STA1 sets the CW as CWmin. Because STA1 is in the OUT state with a BC value of zero, STA1 transmits after the medium becomes idle for the PIFS interval 505. STA1 appends the next BC value 510 generated from a uniform distribution in [0, CW]. In this example, as shown in the reservation table 515, STA1 has generated the BC value 510 identifying time slot 2 and switches to the IN state (assuming the transmission was successful). For each idle time slot beginning at the boundary of the DIFS interval 520, STA1 decrements all BC values in the reservation table 515. After the DIFS interval 520 and one time slot 525, STA1 transmits the next data frame 530 and BC value 535. Since STA1 is in the IN state, STA1 selects the lowest available time slot, namely, time slot 1 as its next BC value. The reservation table 540 illustrates the reservation table 335 at this time, namely, including STA1 in time slot 1. STA1 repeats the procedure after the backoff counter reaches zero. Since STA1 is the only STA 204 on the RDCA network 200, STA1 selects time slot 1 again.

FIG. 5(b) is a timing diagram illustrating reservation table management for STA1 of FIG. 5(a) after it reaches steady-state in the RDCA network 200, in accordance with an embodiment of the present invention. As shown, STA1 will successively transmit packets separated only by a DIFS interval 545.

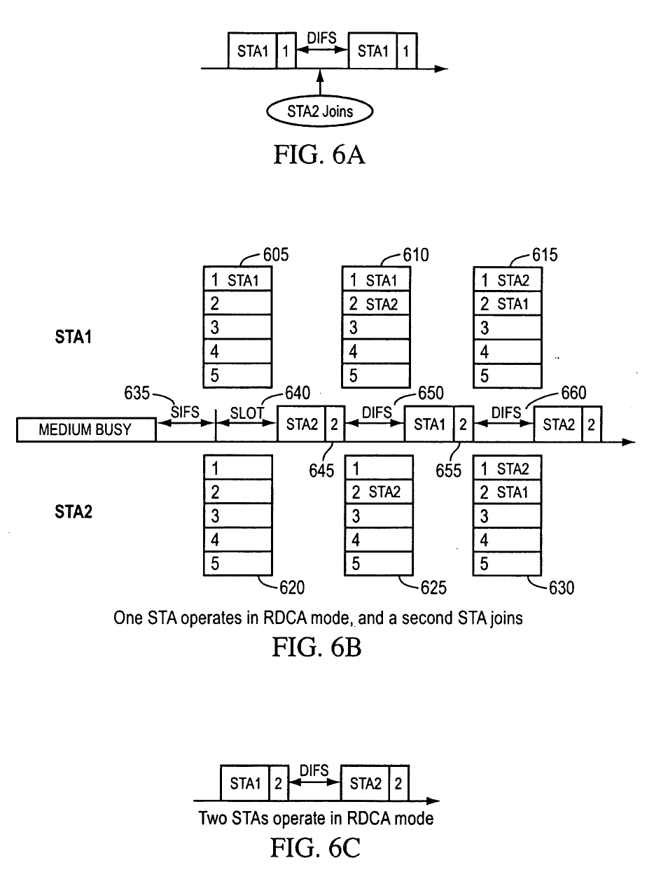

FIG. 6(a) is a timing diagram illustrating STA2 joining the RDCA network 200 of FIG. 5(b) with STA1 already in steady-state, in accordance with an embodiment of the present invention.

FIG. 6(b) is a timing diagram illustrating reservation table management of the STA1 and STA2 of FIG. 6(a) as they settle towards steady-state, in accordance with an embodiment of the present invention. When STA2 joins the RDCA network 200, STA2 sets its state as IDLE. As shown by the reservation table 605, since STA1 is in steady-state, STA1 initially reserves time slot 1. As shown by reservation table 620, since STA2 has just joined the RDCA network 200, STA2 is not aware of any reserved time slots. If STA2 has packets to send, STA2 sets the BC value to zero, sets CW to CWmin and switches to the OUT state. Because STA2 is in OUT state with a BC value of zero, STA2 transmits after the medium becomes idle for SIFS 635 plus one time slot 640, ahead of STA1 (since STA1 must wait for a DIFS interval). STA1 selects and advertises the next BC value 645 generated from a uniform distribution in [0, CWmin], in this case, equal to time slot 2. If the received BC value happened to be the same as the BC value of STA1, namely, time slot 1, STA1 would have switched to the OUT state. However, as shown, STA1 selected an unreserved time slot. Assuming the transmission was successful, STA2 switches to the IN state. STA1 marks the advertised BC value of 2 in the reservation table 610 as reserved by STA1. STA1 marks its reserved BC value in its own reservation table 625. At the slot boundary after the medium becomes idle for a DIFS interval 650, STA1 decrements the BC values in the reservation table 335 and transmits its data and next BC value 655 as the smallest available value in its reservation table 610 after decrementing. Thus, since after decrementing STA1 reserves time slot 1, STA1 selects time slot 2 as the next available time slot. Accordingly, STA1 updates its reservation table 615 to include its reserved time slot 2. Similarly, STA2 updates its reservation table 630 to include reserved time slot 2 of STA1. Then, after DIFS interval 660, STA2 transmits its packet.

FIG. 6(c) is a timing diagram illustrating STA1 and STA2 of FIG. 6(b) after they reach steady-state, in accordance with an embodiment of the present invention. As shown, now that each of STA1 and STA2 is aware of the BC value reserved by the other, they transmit packets one after another separated by DIFS without collisions.

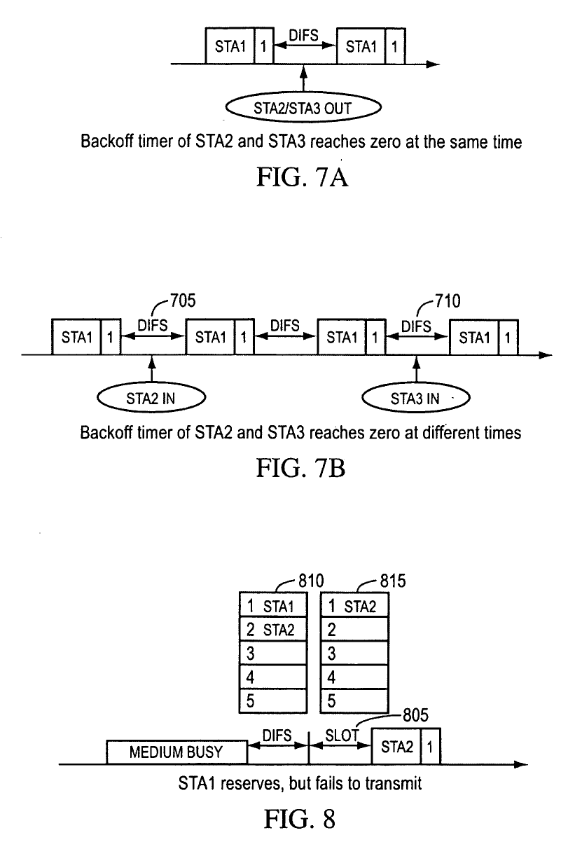

FIG. 7(a) is a timing diagram illustrating STA2 and a third STA (STA3) Simultaneously joining the RDCA network 200 of FIG. 5(b), in accordance with an embodiment of the present invention. If STA2 and STA3 join the network at the same time or if STA2 causes STA1 to switch to the OUT state by advertising the same BC value and STA2 has an ACK failure, collisions occur. The chance of either above scenario is very low.

FIG. 7(b) is a timing diagram illustrating the backoff timing mechanism handling the simultaneous joining of STA2 and STA3 of FIG. 7(a), in accordance with an embodiment of the present invention. Upon joining, STA1 and STA2 will each try to transmit at the same time, namely, alter a PIFS interval. When a collision occurs, each of STA2 and STA3 remains in the OUT state and generates a BC value from a uniform distribution between 0 and CW, determined per conventional DCF procedures. Note that CW may be different for different STAs. Each STA transmits after the medium is idle for a PIFS interval after its backoff timer reaches zero. If collision happens again, the station doubles CW until CWmax and repeats the procedure. As shown, based on the BC values generated, STA2 enters the packet stream before the expiry of the DIFS interval 705 and STA3 enters the packet stream before the expiry of the DIFS interval 710.

FIG. 8 is a timing diagram illustrating reservation table management when one of two STAs on the RDCA network 200 fails to transmit in its reserved time slot, in accordance with an embodiment of the present invention. If a STA reserves a time slot but later fails to transmit a packet in that time slot, no modification of the process is needed. For example, as shown in reservation table 810, STA1 reserves time slot 1. If STA1 fails to transmit, the BC values in all reservation tables 335 decrement for idle time slot 805. As a result, as shown in reservation table 815, the STA which reserves the next time slot, namely, STA2, will transmit in the next time slot.

FIG. 9 is a state transition diagram 900, in accordance with an embodiment of the present invention. As shown, a STA is in the IDLE state when it first joins the RDCA network 200. The STA switches to the OUT state when it has at least one packet to be transmitted. If the STA undergoes a successful transmission, the STA switches to the IN state. After each successful transmission in the IN state, the STA remains in the IN state. If a transmission is unsuccessful or if the STA receives an advertised BC value which is the same as its own, the STA moves from the IN state to the OUT state. After each unsuccessful transmission, a STA in the OUT state stays in OUT state. When a STA in either the IN state or the OUT state does not have any packets to send, the STA switches to the IDLE state.

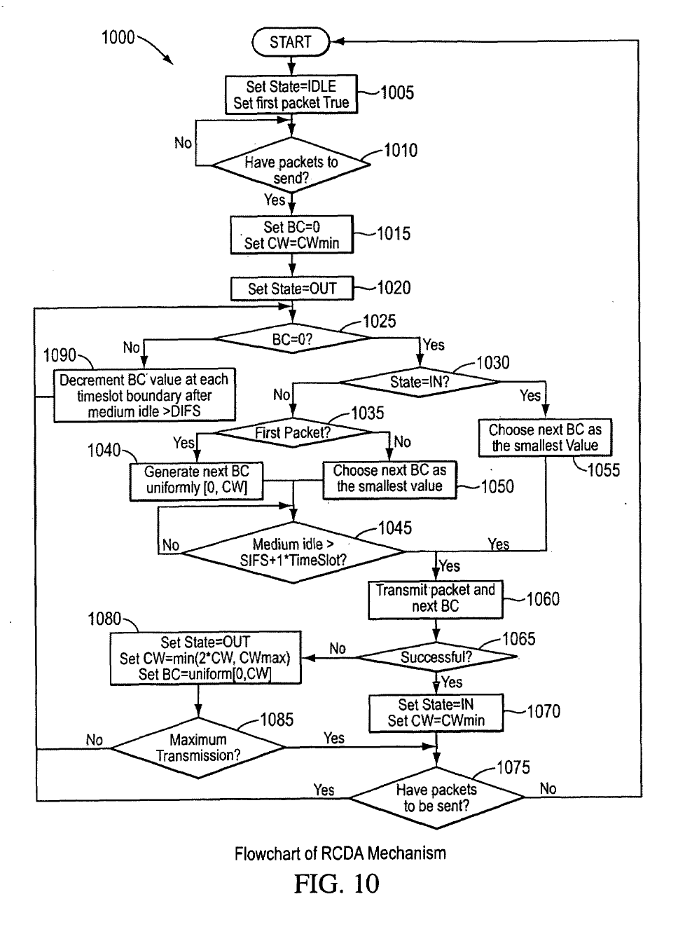

FIG. 10 is a flowchart illustrating a method 1000 of performing reservation-based distributed collision avoidance channel access, in accordance with an embodiment of the present invention. The method 1000 begins with the state engine 320 in step 1005 setting the state to IDLE and FIRST. The RDCA medium access engine 305 in step 1010 determining whether there are any packets to send. If not, then method 1000 returns to step 1010. Otherwise, the BC value determination engine 315 in step 1015 sets the BC value to zero and CW to CWmin. The state engine 320 in step 1020 switches the state to OUT.

In step 1025, the RDCA medium access engine 305 determines if the backoff counter 310 is equal to zero. If not, then in step 1090 the backoff counter 310 decrements the BC value and the reservation table management engine 330 decrements the reserved time slots after the DIFS interval and for each idle time slot thereafter.

If the backoff counter is equal to zero, then the BC value determination engine 315 in step 1030 determines if the state is equal to IN. If the state is not IN (i.e., the state is OUT), then the BC value determination engine 315 in step 1035 determines if the state is equal to FIRST (i.e., this is the first packet the STA is transmitting on the RDCA network 200) or NOT FIRST (i.e., this is not the first packet the STA is transmitting on the RDCA network 200). If the state is OUT and FIRST, then the BC value determination engine 315 in step 1040 generates the next BC value from the uniform distribution between 0 and CW. If the state is OUT and NOT FIRST, then the BC value determination engine 315 in step 1050 selects the lowest available time slot from the reservation table 335 as the next BC value. Then, the RDCA medium access engine 305 in step 1045 determines when the medium is idle for a PIFS interval. If not, then method 1000 returns to step 1045. If idle for a PIFS interval, then method 1000 proceeds to step 1060.

If the state is IN, then the BC value determination engine 315 in step 1055 selects the lowest available time slot from the reservation table 335 as its next BC value. Then, the method 1000 proceeds to step 1060.

In step 1060, the RDCA medium access engine 305 transmits the packet, including the next BC value. The RDCA medium access engine 305 in step 1065 determines whether the transmission was successful. If the transmission is successful, then in step 1070 the state engine 320 sets the state to IN and the BC value determination engine 315 sets CW to CWmin. The RDCA medium access engine 305 in step 1075 determines if there are any more packets to send. If not, then method 1000 returns to step 1005. If so, then method 1000 returns to step 1025.

If the transmission is unsuccessful, then in step 1080 the state engine 320 sets the state to OUT, the BC value determination engine 315 sets CW to the minimum of the group including 2*CW and CWmax, and the BC value determination engine 315 selects a value from the uniform distribution between 0 and CW as the next BC value. The RDCA medium access engine 305 in step 1085 determines whether the STA has exceeded a maximum number of transmission attempts. If not, then method 1000 returns to step 1025. If so, then method 1000 proceeds to step 1075 to select another packet.

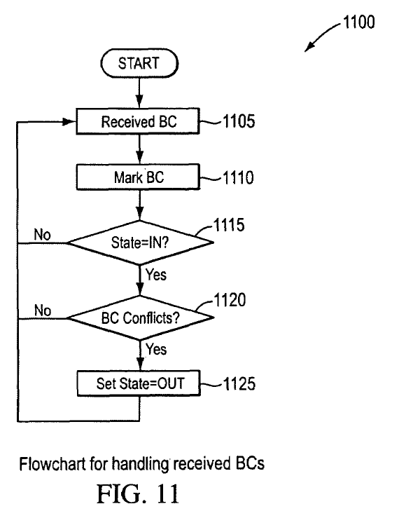

FIG. 11 is a flowchart illustrating a method 1100 of handling received backoff counter values, in accordance with an embodiment of the present invention. The method 1100 begins with the reservation table management engine 330 (via the RDCA medium access engine 305) in step 1105 receiving a BC value of another STA. The reservation table management engine 330 in step 1110 marks the BC value in the reservation table 335. The state engine 320 in step 1115 determines whether the state is currently IN. If not, then method 1100 returns to step 1105. If so, then the state engine 320 in step 1120 determines if the advertised BC value conflicts with its BC value. If not, then method 1100 returns to step 1105. If so, then the state engine 320 sets the state to OUT. Method 1100 then returns to step 1105.

Several variations of the RDCA controller 245 are described below:

For example, instead of advertising the smallest available BC as the next BC when a STA is in the IN state, the controller 245 can prioritize traffic by employing different BC value determination algorithms based on different traffic types. For example, a STA with delay insensitive traffic can generate the next BC value by a uniform distribution in [0, CW] and avoid the values already used by other STAs. A STA having traffic with delay requirements can set the next BC value as the smallest available value. As a result, delay sensitive traffic will have higher priority to access the channel than delay insensitive applications.

Further, traffic prioritization can be achieved by allowing multiple future BC value advertisements in a transmission. That is, a STA can reserve multiple time slots for delay sensitive traffic and fewer or only one time slot for delay insensitive traffic.

The proposed scheme facilitates high definition video and multiple video reliability and real time transmissions.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A first station for communicating on a wireless network, the station comprising:
memory for indicating whether the first station is in an IN state or an OUT state;
a reservation store for storing reserved time slots of other stations communicating on the wireless network;
a backoff counter (BC) value determination engine for selecting one of the unreserved time slots in the reservation store as the next time slot for a next transmission if the first station is in the IN state, the BC value determination engine for determining the next time slot according to a predetermined algorithm if the first station is in the OUT state; and
a medium access engine for initiating a current transmission during a previously reserved time slot and after a first idle interval if the first station is in the IN state, and for initiating the current transmission during a previously determined time slot and after a second idle interval if the first station is in the OUT state, the second idle interval being shorter than the first idle interval, the current transmission identifying the next time slot.

2. The first station of claim 1, wherein the first station includes a mobile device or an access point.

3. The first station of claim 1, wherein the BC value determination engine selects the lowest available time slot as the next time slot if the station is in the IN state.

4. The first station of claim 1, wherein the BC value determination engine selects the next time slot using a uniform distribution between 0 and a contention window (CW) value if the station is in the OUT state and it's the first transmission of the station.

5. The first station of claim 1, wherein the first idle interval includes a DIFS interval and the second idle interval includes a PIFS interval.

6. The first station of claim 1, further comprising a backoff counter for counting idle time slots until the next time slot.

7. The first station of claim 1, further comprising a state engine for controlling the state of the first station, the state engine for placing the first station in the IN state alter a successful transmission and for placing the first station in the OUT state after an unsuccessful transmission.

8. The first station of claim 7, wherein the state engine controls the state of the first station to switch from the IN state to the OUT state when another time slot is advertised that matches the next time slot of the first station.

9. The first station of claim 7, wherein the state engine controls the state of the first station to switch from the IN state to the OUT state upon a collision.

10. The first station of claim 7, wherein the state engine controls the state of the first station to switch from the IN state to the OUT state upon failure of a success indication.

11. The first station of claim 7, wherein the state engine controls the state of the first station to initiate in the OUT state upon joining the wireless network.

12. A method of communicating on a wireless network by a first station, the method comprising:
storing an indication whether the first station is in an IN state or an OUT state;
storing reserved time slots of other stations communicating on the wireless network in a reservation store;
storing a previously determined time slot of the first station;
selecting one of the unreserved time slots in the reservation store as the next time slot if the first station is in the IN state;
generating the next time slot according to a predetermined algorithm if the first station is in the OUT state;
initialing a current transmission during the previously determined time slot and after a rust idle interval if the first station is in the IN state; and
initialing the current transmission during the previously determined time slot and after a second idle interval if the first station is in the OUT state, the second idle interval being shorter than the first idle interval, the current transmission identifying the next time slot.

13. The method of claim 12, wherein the computing includes selecting the lowest available time slot as the next time slot if the first station is in the IN state.

14. The method of claim 12, wherein the computing includes selecting the next time slot using a uniform distribution between 0 and a contention window (CW) value if the first station is in the OUT state and it's the first transmission of the first station.

15. The method of claim 12, wherein the first idle interval includes a DIFS interval and the second idle interval includes a PIFS interval.

16. The method of claim 12, further comprising placing the first station in the IN state after a successful transmission, and placing the first station in the OUT state after an unsuccessful transmission.

17. The method of claim 12, further comprising switching the state of the first station from the IN state to the OUT state when another time slot is advertised that matches the next time slot of the first station.

18. The method of claim 12, further comprising switching the state of the first station from the IN state to the OUT state upon a collision.

19. The method of claim 12, further comprising switching the state of the first station from the IN state to the OUT state upon failure of a success indication.

20. The method of claim 12, further comprising causing the state of the first station to initiate in the OUT state upon joining the wireless network.
